(19) United States
(12) Patent Application Publication
(10) Pub. No.: US 2012/0204570 A1
(43) Pub. Date: Aug. 16, 2012

(54) Load Control Device and Method for Controlling the Load of an Engine

(75) Inventor: Rüdiger Herdin, Wien (AT)

(73) Assignee: 25 ENERGIETECHNIK GMBH, Heek (DE)

(21) Appl. No.: 13/500,631

(22) PCT Filed: Oct. 14, 2010
(86) PCT No.: PCT/EP2010/065480

§ 371 Date: Apr. 5, 2012

(30) Foreign Application Priority Data
Oct. 14, 2009 (DE) 10 2009 049 394.8

(51) Int. Cl. F02C 9/00; F02C 3/04

(52) U.S. Cl. 60/773; 60/39.24

(57) ABSTRACT

The present invention relates to a load control device for an engine and to a method for controlling the load. The load control device comprises a compressor for compressing air in an intake system of the engine; an exhaust gas line for discharging an exhaust gas mass flow from the engine; a turbine that is driven by an exhaust gas mass flow supplied by the exhaust gas line and that drives the compressor; a bypass line that branches off the exhaust gas line upstream of the turbine, wherein a first valve is disposed in the bypass line for controlling the mass flow in the bypass line; and an active cooling device that is disposed upstream of the valve.

The present invention relates to a device for controlling the load of engines. In particular, the invention relates to the load control of engines, such as gaseous fuel engines, which are supercharged by turbochargers.

Turbochargers are used in engines, in order to compress the air which is fed to the engine for combustion, and therefore to achieve a higher degree of efficiency. Here, the exhaust gas of the engine is used to drive a turbine which in turn drives the compressor.

Furthermore, in many engines, such as Otto engines, the load is controlled by a throttle valve, with the result that the air which is compressed by the compressor is throttled upstream of the engine and is therefore not used in the engine. As a result, the exhaust gas mass flow is reduced, which in turn leads to a reduction in the turbine and compressor performance.

In supercharged engines, such as highly supercharged gaseous fuel engines, this throttle valve is, however, an obstacle to achieving the best possible degree of efficiency or to improving the degree of efficiency, since the excess pressure produced by the compressor is dissipated at the throttle valve for regulating the performance. In addition to the throttle losses on the suction side, the turbine additionally also has to overcome a higher exhaust gas back pressure.

A further possibility for regulating the compression consists of the fact that a part of the exhaust gas mass flow is guided around the turbine by means of a bypass line and therefore cannot contribute to driving of the turbine and therefore also of the compressor. Guiding the exhaust gas mass flow past the exhaust gas turbine is also called the “wastegate”.

However, regulation of this type is associated with a regulating unit, typically in the form of a valve. In order to make accurate regulation via a wastegate possible, said valve has to operate reliably and correctly, however. It is to be taken into consideration here that the regulation should function in a long-lasting manner, in order to ensure customer satisfaction. A defective valve or a valve which is no longer fully functional as a result of wear leads to poor or nonexistent regulation of the exhaust gas mass flow.

The invention is therefore based on the object of developing the device of the generic type in such a way that it overcomes the disadvantages of the prior art, in particular to produce an increased or best possible degree of efficiency and to avoid defects or inaccuracies in the regulation used for this purpose.

According to the invention, the object is achieved by a load control device for an engine, the load control device having an exhaust gas line for discharging an exhaust gas mass flow from the engine; a turbine which is driven by an exhaust gas mass flow which is fed by the exhaust gas line; a bypass line which branches off from the exhaust gas line upstream of the turbine, a first valve for regulating and/or controlling the exhaust gas mass flow; and a cooling device which is arranged upstream of the first valve, for cooling the exhaust gas mass flow. Here, this is typically an active cooling device for the embodiments described herein.

The invention therefore relates to the advantageous cooling of the exhaust gas upstream of the valve (wastegate), with the result that the wastegate can operate at relatively low temperatures.

The invention therefore makes load control of the engine possible, such as in a steady state high load mode, by means of the valve for regulating the exhaust gas mass flow. Here, the engine can be operated in an unthrottled manner, which leads to an improved degree of efficiency. Moreover, the cooling of the exhaust gas flow produces reduced wear at the regulating valve and therefore improved reliability.

According to one aspect of the present invention, the cooling device is arranged between the branch of the bypass line from the exhaust gas line and the first valve. This makes it possible to cool the exhaust gas mass flow which is branched off, in an efficient and targeted manner.

According to a further embodiment, the cooling device is a heat exchanger. This ensures that the exhaust gas mass flow can be cooled in a simple and inexpensive way.

According to a further aspect of the present invention, the first valve comprises, in a valve housing, a valve seat which surrounds a valve opening, and a valve element or valve actuating element, it being possible for the valve element or valve actuating element to be moved relative to the valve seat between a first extreme position, in which the valve element or valve actuating element bears against the valve seat and prevents an exhaust gas mass flow through the first valve, and a second extreme position, in which the valve opening of the first valve is substantially completely open. The mass flow of the exhaust gas flow which is branched off can be regulated by the size of the opening area of the valve opening. Here, the valve actuating element of the first valve can be configured in such a way that an opening area of the first valve has different sizes, in particular in the case of a movement of the valve actuating element between the first extreme position and the second extreme position.

In one embodiment which can be combined with other embodiments, the size of the opening area can decrease continuously, in particular can decrease linearly at least in sections, for example completely, between the first extreme position and the second extreme position of the valve actuating element. For example, a linear section can comprise at least 30% of the actuating travel, in particular at least 40% of the actuating travel. Linear is understood as meaning, for example, that an adjustment travel of the valve actuating element relates linearly to the change in the opening area.

In one preferred embodiment of the present invention, a multiplicity of intermediate positions can be set between the first extreme position and the second extreme position, with the result that, for example, infinitely variable regulation of the load is made possible.

According to a further, preferred aspect, the load control device comprises a second valve, in particular a throttle valve, which is arranged downstream of the compressor and downstream of the engine, the second valve controlling and/or regulating the air or air/fuel mixture which is fed to the engine. Said second valve can serve for safety purposes, but can also supplement and/or assist the function of the first valve in the bypass line in some operating states, such as during the running up to the high load mode.

According to one aspect of the present invention, the load control device comprises a regulating and/or control device for controlling and/or regulating the first valve and optionally also the second valve. This can help to use the complex regulating and control activities correctly.

According to one preferred embodiment, the regulating and/or control device is set up for carrying out a regulation of the first valve for the exhaust gas mass flow, whereas, typically in the high load mode, a regulation of the throttle valve does not take place. Typically, the position of the throttle valve in conjunction with the steady state operating state can only be monitored, but is not used for the regulation of the load.

In a further embodiment, the regulating and/or control device is set up such that the pressure difference at the throttle valve is used as controlled variable before the transfer of the load control from the throttle valve to the relief valve. In general, the regulating and/or control device is set up to carry out the control and/or the regulation of the first valve and/or of the second valve as a function of a pressure difference at the second valve. Individual regulation is made possible as a result. For example, the pressure difference of the pressures in flow terms upstream and downstream of the second valve is used for control and/or regulation.

In one embodiment, the regulating and/or control device is set up to carry out the control and/or the regulation of the first valve and/or of the second valve as a function of a reference signal of the shaft rotational speed of the turbine. This makes it possible to determine the influence of the load control measures.

Typically, cooling by the heat exchanger takes place without additional regulation of the cooling. On the other hand, however, it is possible to influence the cooling, for example, via the throughflow quantity of the cooling fluid in a heat exchanger. Therefore, according to a further aspect of the present invention, the regulating and/or control device is set up to regulate and/or to control the active cooling device. In particular, the regulating and/or control device can control and/or regulate the cooling device as a function of one or more exhaust gas properties. As a result, the temperature of the exhaust gas mass flow in the bypass line can be set.

According to one embodiment, the load control device is set up to be used in a gaseous fuel engine. In a further embodiment, the load control device is set up to be used in an Otto engine.

In one embodiment, the engine is set up to be used in a biogas plant. As a result, biogas plants can be of even more effective design and the environmentally friendly production of energy becomes more attractive.

One embodiment of the present invention is designed in such a way that the bypass line opens downstream of the turbine into an exhaust gas system of the engine and/or the turbine. As a result, simple discharging of the exhaust gas mass flow which is branched off in the bypass line is made possible.

In a second aspect, the object is also achieved according to the invention by a method for controlling the load of an engine. The method comprises controlled blowing off of exhaust gas upstream of the turbine, and cooling of an exhaust gas mass flow which is fed to the relief valve. Typically, a compressor for compressing air or an air/fuel mixture in an intake section of the engine, an exhaust gas line for blowing off or discharging an exhaust gas mass flow from the engine, and a turbine which is driven by an exhaust gas mass flow fed by the exhaust gas line and which drives the compressor can be provided. Furthermore, the method can typically comprise branching off of a part of the exhaust gas mass flow upstream of the turbine, the exhaust gas mass flow which is branched off in a bypass line being regulated and/or controlled by means of a first valve, the cooling of the exhaust gas flow which is branched off taking place upstream of the first valve.

According to one aspect of the present invention, although this is not necessary, the cooling of the exhaust gas mass flow which is branched off can be regulated and/or controlled, in particular as a function of exhaust gas properties. According to a further embodiment, the cooling control and/or regulation of the exhaust gas mass flow which is branched off takes place as a function of the dew point of the exhaust gas and/or of a constituent part of the exhaust gas. This makes an optimum mass throughflow through the valve possible and ensures a maximum service life of the valve. According to a typical embodiment, the cooling can be dimensioned such that, even without regulation or control, cooling can be provided in a steady state in such a way that the temperature ranges described herein, for example approximately from 10° C. to 50° C. above the dew point of the exhaust gas, can be made available.

In one embodiment of the present invention, the exhaust gas mass flow which is branched off is cooled as a function of an acid dew point. This is advantageous, for example, in biogas plants. According to one aspect, the temperature of the exhaust gas mass flow is controlled, regulated or provided for typical steady state operation by way of a fixedly predimensioned cooling unit in such a way that said temperature exceeds the dew point and/or the acid dew point. As a result, depositing of constituent parts of the exhaust gas in the first valve can be prevented.

In one embodiment of the present invention, should a controller be present, the temperature of the exhaust gas mass flow which is branched off is controlled and/or regulated to a setpoint temperature, the setpoint temperature being, in particular, above the acid dew point, in particular over from 5 to 20° C. above the acid dew point. The setpoint temperature can therefore be a basis for the regulation of the cooling.

According to one embodiment, the regulation and/or control of the cooling is carried out with an accuracy in the temperature range between 1° C. and 10° C., in particular between 1° C. and 5° C., preferably between 1° C. and 3° C., in particular around the setpoint temperature. As a result, the risk is reduced that undesirable deposits appear in the valve as a result of temperature fluctuations.

In one embodiment of the load control method according to the invention, the regulation of the first valve is combined with the regulation of a second valve, in particular of a throttle valve, which is arranged downstream of the compressor, in particular for non-steady state operating states, for example the reaching of a steady state operating state. In particular, the first and the second valve are regulated and/or controlled as a function of one another. As a result, both the first and the second valve can be set as a function of one another.

According to one embodiment, an opening area size of the valve and optionally also of the second valve for some operating times is regulated and/or controlled as a function of a reference signal of the shaft rotational speed of the turbine. As a result, a direct influence on the regulation and/or control is controlled.

In a further aspect, the invention describes the regulation and/or the control of the first valve and/or of the second valve as a function of the pressure difference at the throttle valve.

According to one aspect of the present invention, an opening area size of the first valve in the bypass line is controlled in a first operating phase, in particular is controlled step by step, and is then regulated in a second operating phase. According to a further embodiment, the opening area size of the valve is controlled in the first operating phase in an actuating operation mode. In one embodiment of the present invention, discrete intermediate positions and/or opening area sizes of the first valve are actuated in the first operating phase.

In a further embodiment, the opening area or the opening area size of the first valve is controlled and/or regulated in such a way that the second valve is opened completely. As a result, a maximization of the degree of efficiency can be realized, since the throttle valve can always remain completely open.

In a third aspect, the present invention comprises a method, as has been described above, for operating a load control device, as has been described above.

Further advantageous embodiments, refinements and aspects of the present invention result from the dependent patent claims, the description and the appended drawings, in which:

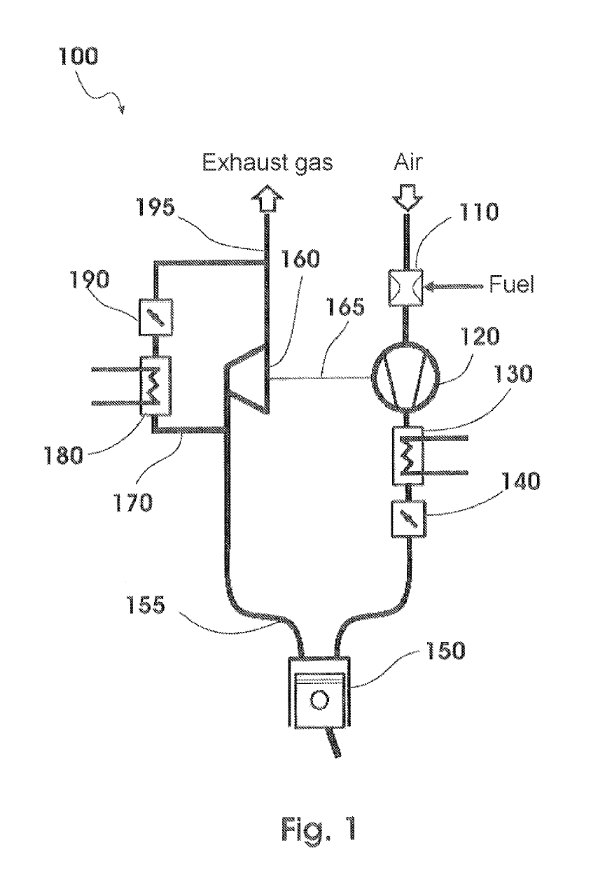

FIG. 1 shows a diagrammatic drawing of a load control device according to one embodiment of the present invention;

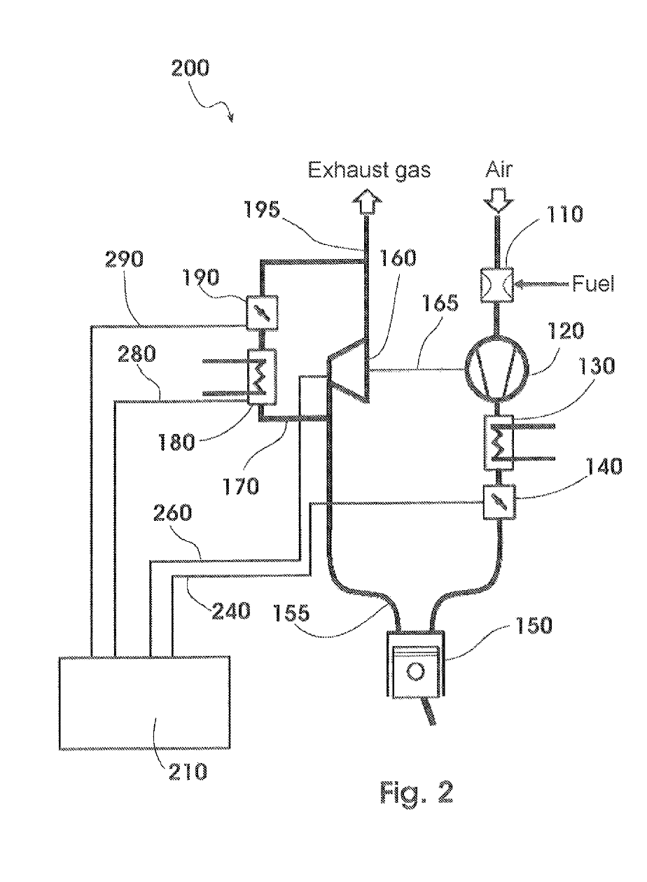

FIG. 2 shows a diagrammatic drawing of a load control device with a regulating and/or control device according to one embodiment of the present invention;

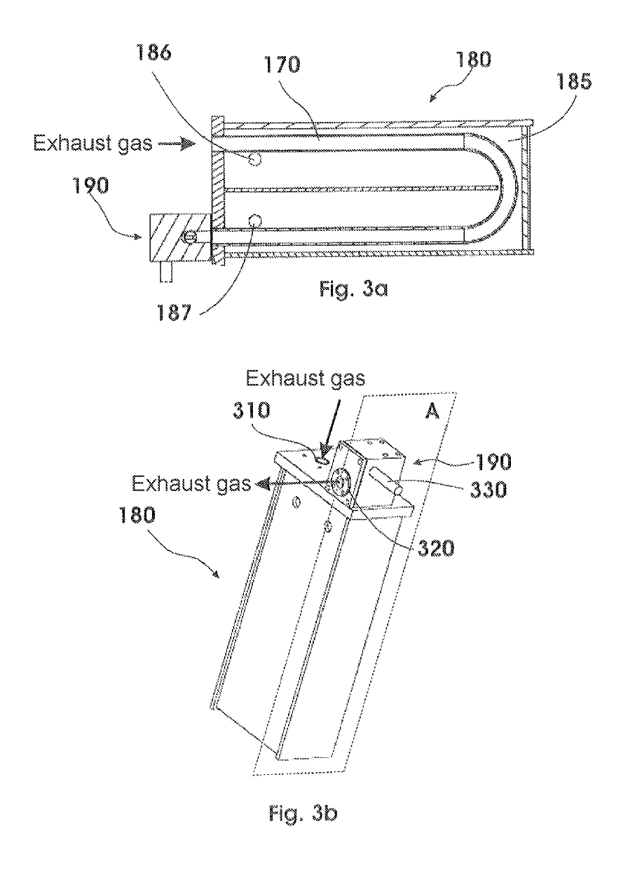

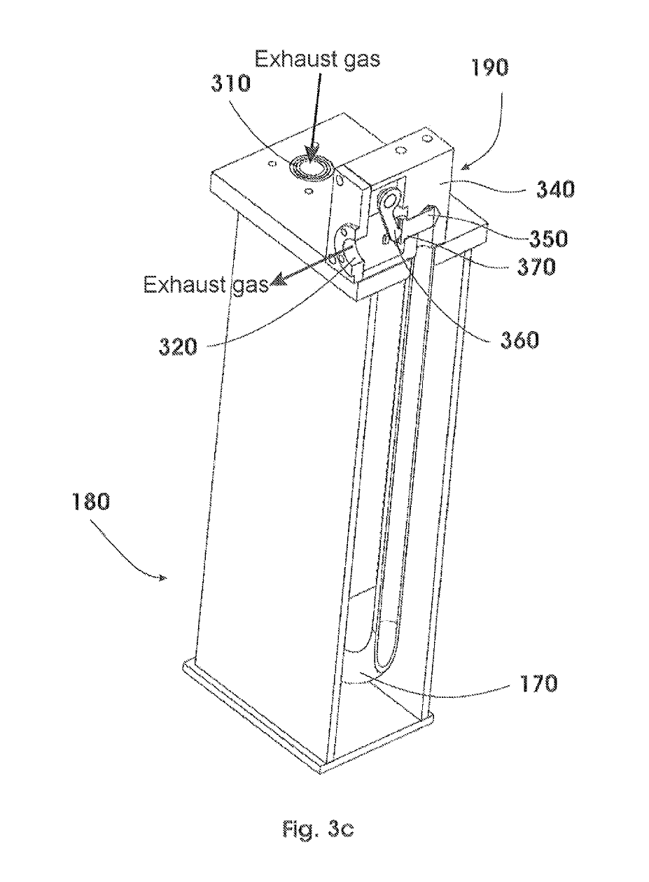

FIG. 3a shows a sectional view of a cooling device with the first valve in the bypass line according to one embodiment of the present invention;

FIG. 3b shows a diagrammatic 3D view of a cooling device with the first valve according to one embodiment of the present invention;

FIG. 3c shows a diagrammatic 3D sectional view of a cooling device with the first valve according to one embodiment of the present invention;

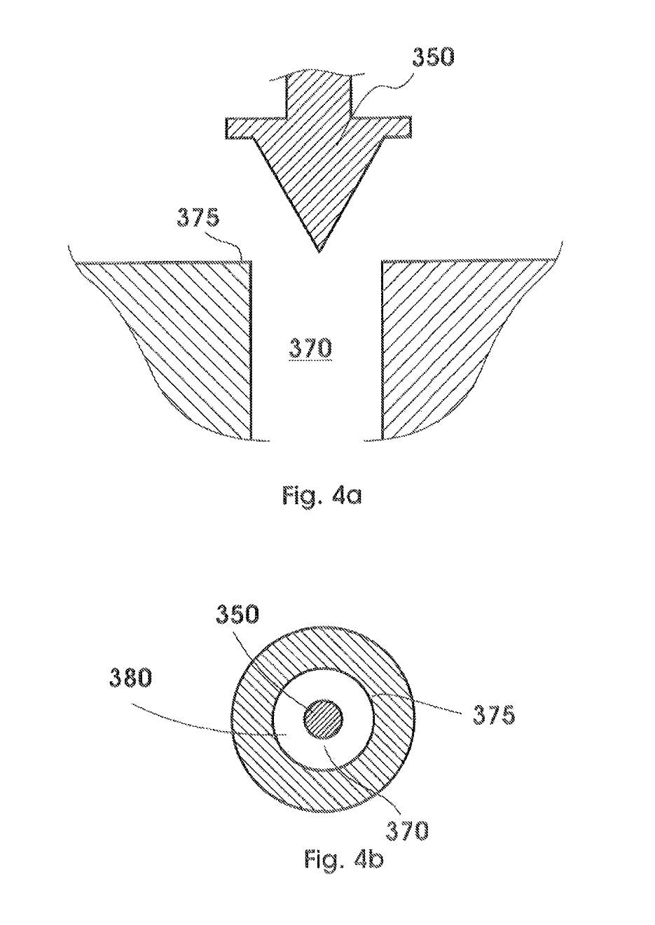

FIG. 4a shows a diagrammatic sectional view of a detail of the first valve according to one embodiment of the present invention;

FIG. 4b shows a diagrammatic plan view of the detail shown in FIG. 4a, according to one embodiment of the present invention;

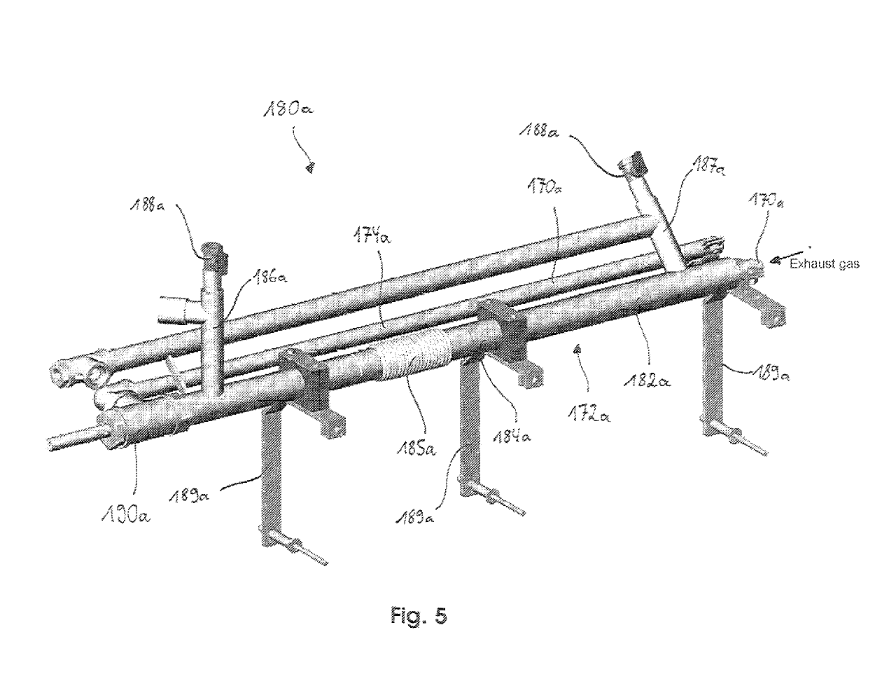

FIG. 5 shows a perspective view of one embodiment of a cooling device;

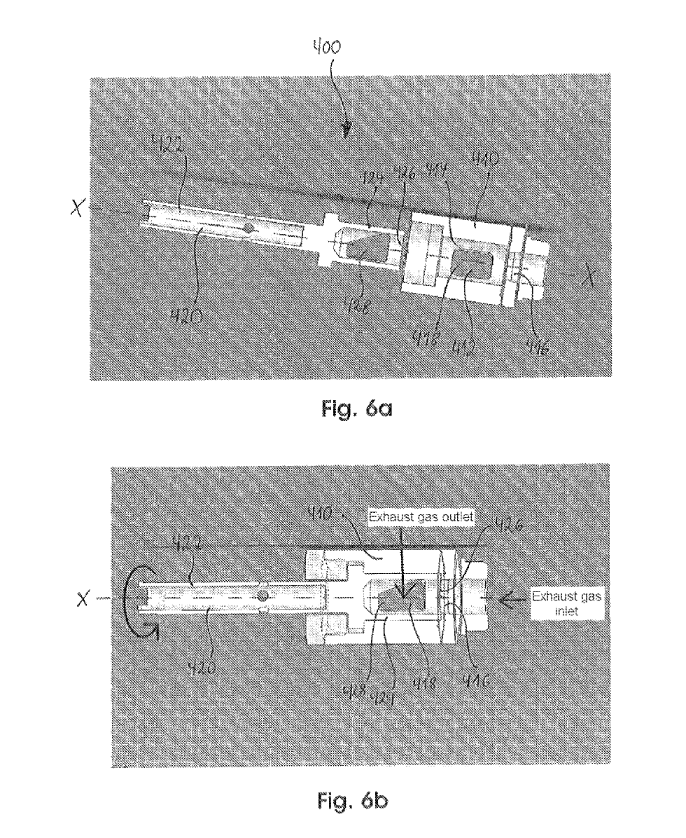

FIG. 6a shows a half-section/exploded view of a first valve of a further embodiment;

FIG. 6b shows a sectional view of the embodiment of the valve according to FIG. 6a;

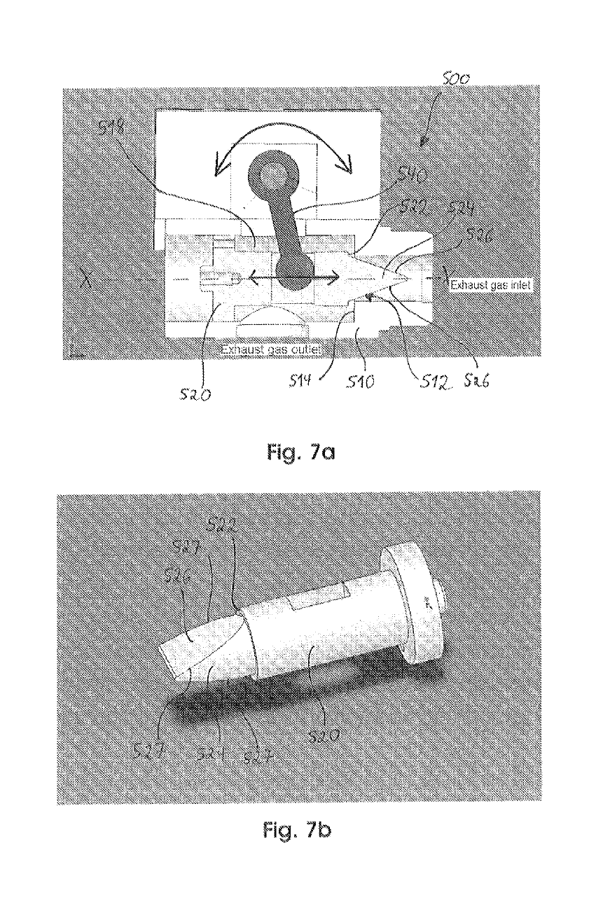

FIG. 7a shows a cross-sectional view of a first valve of another embodiment;

FIG. 7b shows a perspective view of the valve body of the first valve from FIG. 7a;

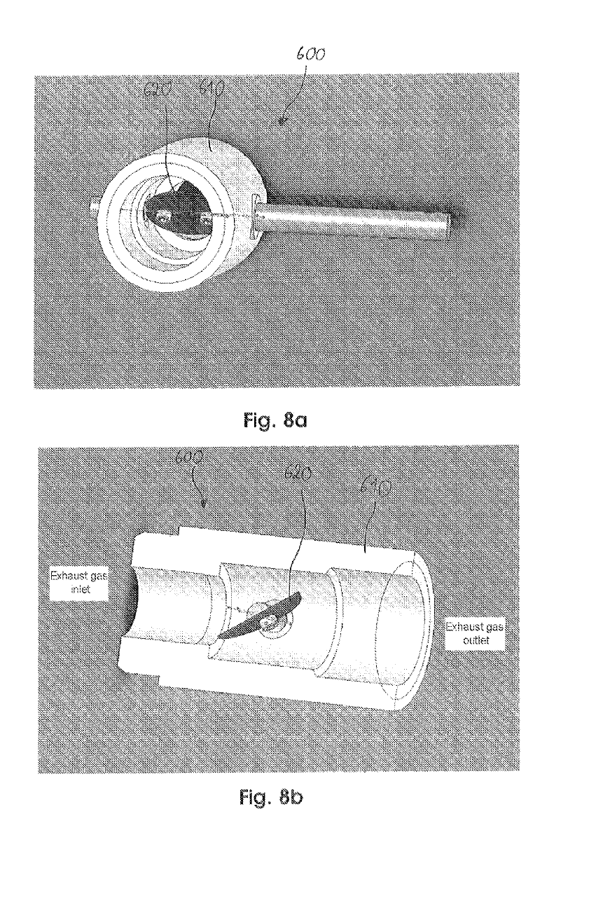

FIG. 8a shows a perspective view of a further embodiment of a first valve; and

FIG. 8b shows a sectional view of the first valve according to the embodiment from FIG. 8a.

The following description relates by way of example to gaseous fuel engines, but can also be applied to other engines. The respective adaptations for the various engine types will be described only briefly. It should be understood that an engine of a different type can be equipped with the load control device of the present invention and can optionally be adapted.

FIG. 1 shows a diagrammatic illustration of one embodiment of the present invention. Air is mixed with fuel in a mixer 110. In the embodiment which is shown in FIG. 1, air is mixed with gas, such as biogas, before the air enters the engine 150.

FIG. 1 shows the engine 150 only diagrammatically using one piston. Here, the engine is not restricted to the exemplary embodiment which is shown, but rather can be an engine of any type. For example, the engine 150 can be a diesel engine or an Otto engine. If the engine 150 is operated, for example, with diesel, the mixing device 110 can be arranged at another location. In the case of an Otto engine which is operated with gasoline, the mixing device 110 can be omitted, since the fuel injection takes place directly into the combustion chamber or into the intake manifold.

The arrows in FIG. 1 denote the flow direction. Air or the air/gas mixture flows toward the engine 150 and exhaust gas flows away from the engine 150.

A compressor 120 which compresses the air/gas mixture is arranged downstream of the mixer 110. The compressed air/gas mixture is cooled in an intercooler 130 in a typical, exemplary embodiment. The intercooler 130 can also be called a charge air cooler. A throttle valve 140 which is in turn arranged downstream of the intercooler 130 can regulate the mass flow of the compressed air/gas mixture. The throttle valve 140 can also serve for safety, in order to avoid an undesirable excess pressure.

The compressed, cooled and regulated mass flow of the air/gas mixture is then burned in the engine 150. The burned air/fuel mixture, the exhaust gas, is conducted away from the engine through an exhaust gas line 155. The exhaust gas is fed to a turbine 160 and drives the latter.

The turbine 160 drives the compressor 120, which happens, for example, by a connection of the turbine 160 to the compressor 120 by means of a shaft 165.

A bypass line 170 branches off from the exhaust gas line 155 upstream of the turbine 160. The bypass line 170 is designed to receive a part of the total mass flow of the exhaust gas. According to another embodiment, the bypass line 170 can also be designed to receive the total mass flow of the exhaust gas.

A cooling device 180 and a first valve 190 are attached upstream in the bypass line 170. The cooling device 180 can be, for example, a heat exchanger. The first valve 190 is also called a wastegate valve. The first valve 190 serves to regulate the mass flow through the turbine 160 and through the bypass line 170. According to one embodiment of the present invention, the regulation of the mass flow takes place by the first valve 190 downstream of the cooling device. Wear of the valve can be reduced by the cooling of that part mass flow of the exhaust gas which is branched off in the bypass line, with the result that the first valve 190 is actuated precisely and reliably for a long time.

According to some embodiments, the throttle valve can be used during the running up to load of the engine. For example, the engine can be started with load control via the throttle valve. When the engine is being run to load, the first valve, that is to say the wastegate and the throttle valve are being opened. Subsequently, the wastegate is closed continuously or in steps, for example first of all in an actuating operation mode, optionally with individual steps. Subsequently, when a range around the optimum boost pressure or the optimum boost pressure of the engine has been reached, the regulating circuit assumes the control of the wastegate.

In biogas plants, for example, on account of the H₂S (combustion product SO₂) which is contained in the biogas, the cooling can take place by an expedient design of a heat exchanger to a temperature level just above the acid dew point. As a result, condensation of substances contained in the exhaust gas can be prevented and the first valve can operate precisely for a long time, which, inter alia, also extends the operating time of the first valve. According to one embodiment of the present invention, the heat which is contained in the exhaust gas can be incorporated directly into the heat extraction of the biogas plant.

Furthermore, the efficacy of the first valve is increased by the cooling of the part mass flow, since the exhaust gas which is compressed by the cooling can be discharged more rapidly through the opening area of the first valve 190. In general, as a result, the reaction time of the regulation is shortened and the performance is improved. The opening area of the valve can also be called the opening cross section.

According to one embodiment of the present invention, the first valve 190 itself is not cooled actively, with the result that the first valve operates at the temperature which is defined by the part mass flow of the exhaust gas. As a result, a formation of condensate in the valve region can be prevented.

According to one embodiment, the throttle valve 140 can also be called a second valve 140 in relation to the first valve 190. The second valve 140 is not restricted to the embodiment of a throttle valve and can be any desired valve which fulfills the functional features.

According to one embodiment of the present invention which can be combined with other embodiments described herein, the first valve 190 is designed such that an opening cross section or the size of an opening area can be changed continuously. In other words, it is possible by way of the valve according to embodiments of the present invention to regulate the part mass flow of the exhaust gas in an infinitely variable manner.

According to one aspect of the present invention, the opening cross section of the valve can be changed continuously between two extreme positions. The two extreme positions can be, for example, the position “completely open” and the position “completely closed”. As a result, any desired exhaust gas part mass flow can be provided as required by the opening cross section. An intermediate position should be understood as being a position which can lie as desired between the extreme positions.

That part mass flow of the exhaust gas which is regulated by the first valve is fed to an exhaust gas system 195 downstream of the turbine 160. That part mass flow of the exhaust gas which has passed the turbine 160 can also be fed to said exhaust gas system 195. The exhaust gas system 195 can comprise, for example, one or more catalytic converters or the like. Only one line 195 which conducts the exhaust gas away is shown here in simplified form.

In some embodiments of the present invention which can be combined with other embodiments, the present invention comprises a regulating and/or control device. FIG. 2 shows by way of example a load control device 200 with a regulating and/or control device 210 according to one embodiment of the present invention. In this example which is shown in FIG. 2, the regulating and/or control device 210 is connected to the first valve 190 by a connection 290. The regulating and/or control device 210 is designed for regulating and/or for controlling at least the valve opening of the valve 190. According to one embodiment of the present invention, the regulating and/or control device can be a load control management means.

According to a further optional embodiment, the regulating and/or control device 210 can also be connected to the cooling device 180 by a connection 280. Here, a regulation is possible with an accuracy of the temperature range of between 1° C. and 10° C., in particular of between 1° C. and 5° C., preferably of between 1° C. and 3° C. Typically, however, the cooling can also have already been designed in advance such that the cooling makes an optimum temperature at the wastegate possible in a steady state operating state. Depending on the surrounding conditions, a precision adjustment of the cooling temperature can take place during the startup or servicing of the engine, for example by way of the throughflow quantity of the cooling fluid in the heat exchanger.

According to one preferred embodiment, the regulating and/or control device also has a connection 240 to the throttle valve 140. As a result, the opening width of the throttle valve 140 can be regulated and/or controlled.

The embodiments of the invention which are described here serve to make load control possible during steady state high load operation, the load control not, or no longer, being effected by the throttle valve but rather by the relief valve (wastegate), that is to say the first valve 190. As a result of this design, the Otto engine can then be operated in an unthrottled manner and therefore at the maximum possible degree of efficiency.

In addition, however, operating forms other than steady state high load operation are also possible. For instance, the first valve 190 and the second valve 140 can be regulated in combination in other operating modes. For example, the first valve 190 in the bypass line 170 is regulated and/or controlled, for example, as a function of the opening state of the second valve.

In general, the first valve can be regulated in such a way that the second valve can be operated in a completely open state. This makes maximum efficiency possible, since the regulation and/or control of the turbine and compressor performance are/is influenced by the first valve, without influencing the flow and pressure conditions downstream of the compressor.

According to one preferred embodiment, in a first operating phase, the first valve 190 will assume the regulating work from the throttle valve after reaching the full load, first of all in an actuating operation mode (for example, with individual steps) and only then by the regulating circuit which is provided. Actuating operation mode is to be understood as meaning a regulation operation, in which the opening area or the opening cross section is widened or constricted by predefined steps. The predefined steps can be determined uniquely as a function of the engine, in which the load control device is used, and of the characteristics of the engine and/or of the turbocharger. Here, the first valve assumes the regulating work of the second valve after reaching the full load, first of all in an actuating operation mode (preferably in individual steps) and only then in a second operating phase by means of the regulating circuit which is provided.

It should be understood here that, although the first and second operating phases can be performed in this order, the first operating phase can follow the second again in another embodiment, depending on the situation.

According to one preferred embodiment, the regulating and/or control device is also connected to the turbine 160 via a connection 260.

The connections 240, 260, 280 and 290 can be connections which are designed for data transfer. According to a further embodiment, however, the connections of the regulating and/or control device can also have further functions and/or elements. The diagrammatically shown connections of the regulating and/or control device can contain, for example, measuring devices or local memories.

According to one preferred embodiment, the regulating and/or control device can detect and evaluate data by way of the connections 240, 260, 280 and 290. For example, the regulating and/or control device 210 can detect a reference signal of the turbine rotational speed by way of the connection 260 and use it to carry out the load control, that is to say the shaft rotational speed of the turbocharger is used as controlled variable. Here, the expression “reference signal” represents a signal which has a relationship to the variable to be measured or is even the variable to be measured itself.

In this description, the expression “controlled variable” relates to a regulating parameter which is used to calculate the required regulation, in order to obtain a desired state. The effectiveness of a measure which is carried out for regulation can be checked by way of a change in the controlled variable. The state which is detected by the changed controlled variable can in turn trigger further regulating operations.

According to another embodiment, the regulating and/or control device 210 can determine the pressure difference at the throttle valve 140 by way of the connection 240 or initiate a measurement of the pressure difference. The pressure difference can then be used by the regulating and/or control device to carry out the load control in a suitable and adapted manner. Here, the pressure difference is used as controlled variable, typically before the transfer of the load control from the throttle valve to the first valve.

As a result of embodiments of the invention which are described herein, it can be prevented that, in the case of, for example, highly supercharged gaseous fuel engines, the throttle valve, the second valve as described here, represents an obstacle in reaching the best possible or improved degree of efficiency, since the excess pressure at the throttle valve, which excess pressure is produced by the compressor, has to be dissipated in order to regulate the performance. In addition to the throttle losses on the suction side, the turbine additionally also has to overcome a higher exhaust gas back pressure. In general, a wastegate can be used in diesel engines or even in small Otto engines, in order to make a high boost pressure possible in the low rotational speed range. As a result of the combination of wastegate and cooling of the exhaust gas upstream of the wastegate used, that is to say the first valve described here, the embodiments which are described here afford the advantage that the wastegate can operate at relatively low temperatures. In particular, in the case of the example of biogas plants which are used according to typical embodiments, the cooling can take place to a temperature level just above the acid dew point as a result of an expedient design of a heat exchanger, on account of the H₂S (combustion product SO₂) which is contained in the biogas. The associated heat can also be incorporated directly into the heat extraction of an energy recovery system. In the combination of wastegate and cooling, the load control during steady state high load operation no longer takes place by way of the throttle valve, but rather by way of the relief valve (wastegate). As a result of this design, the Otto engine can be operated in an unthrottled manner and therefore at the maximum possible or an improved degree of efficiency.

Therefore, according to typical embodiments, a device and a method for controlling the load of highly supercharged Otto engines on the basis of controlled blowing off of exhaust gas upstream of the turbine are provided, the exhaust gas mass flow which is fed to the relief valve being cooled. To this end, for example, a first valve is provided which makes the opening of a variable relief cross section possible. As has already been described, according to alternative or additional implementations, a load control management means can be provided which makes combined load control by throttle valve with the relief valve possible. Here, according to an optional further embodiment, the regulation of the load takes place according to requirements and in each case optimized in terms of the degree of efficiency.

According to a further typical embodiment, the exhaust gas is cooled as described above, and the first valve for blowing off is of uncooled configuration, in order to also avoid a formation of condensate in the valve region. To this end, according to a further alternative or additional modification, the design of the relief valve can be distinguished by guidance of the regulating valve element by the adjustment lever on one side and by the valve housing on the other side.

According to further embodiments, the relief valve regulation can also be used to avoid compressor surge (exceeding of the surge limit) in cold ambient conditions in the entire load range (temperature or on the basis of a reference signal of the approach to the surge limit) or in the case of load-controlled braking, and/or the relief valve can assume the regulating work from the throttle valve after full load is reached, first of all in an actuating operation mode (preferably in individual steps) and only then by the regulating circuit which is provided.

FIG. 3a shows a sectional view of one embodiment for the cooling device 180 with a first valve 190. In this embodiment, the bypass line 170 leads through a cooling device 185. In this case, the cooling device 185 is a heat exchanger. A heat exchanger can be filled with a cooling fluid or can have a cooling fluid flowing through it, which cooling fluid absorbs the heat of the part mass flow of the exhaust gas and conducts it away from the exhaust gas. In this embodiment, a fluid inlet 186 and a fluid outlet 187 are shown, through which fluid passes into the heat exchanger. Here, the fluid at the inlet 186 is cooler than at the outlet 187, according to the principle of the heat exchanger.

FIG. 3b shows the same embodiment of a cooling device 180 as FIG. 3a in a 3D view. In this view, the inlet opening 310 and the outlet opening 320 of the exhaust gas into and out of the cooling device 180 can be seen. It is also apparent from FIG. 3b that the first valve 190 itself is not actively cooled. An adjustment lever 330 is attached to the first valve 190, in order for it to be possible to operate the first valve.

According to other embodiments of the present invention, the first valve can also be actuated by another mechanism. For example, the valve can be actuated electronically or magnetically.

FIG. 3c shows a sectional view in 3D of the embodiment of FIGS. 3a and 3b. Here, the sectional plane runs along the plane A, as is shown in FIG. 3b. In an analogous manner to FIGS. 3a and 3b, the bypass line 170, the cooling device 180 and the first valve 190 are shown.

According to one embodiment of the present invention, the first valve 190 comprises a valve housing 340, a regulating valve element 350 and an adjustment mechanism 360 which is connected to the adjustment lever (cannot be seen in FIG. 3c). According to one typical embodiment, the relief valve, that is to say the first valve 190, is distinguished by guidance of the regulating valve element by the adjustment lever on one side and by the valve housing on the other side.

In the exemplary embodiment which is shown, the adjustment mechanism 360 is actuated by the adjustment lever and brings about a movement of the regulating valve element 350. According to one preferred embodiment, the regulating valve element 350 can have the shape of a pyramid or a pyramid-like shape. Pyramid-like can be, for example, a truncated pyramid or another shape which is based on the pyramid. According to a further aspect, the regulating valve element 350 can also have the shape of a cone or a cone-like shape. Cone-like can be, for example, a truncated cone or another shape which is based on the cone.

According to further embodiments of the present invention, the regulating valve element 350 is introduced into a preferably round hole 370 in the valve housing 340 and/or is configured to change the cross section of the hole 370. As a result, the mass flow of the exhaust gas which flows through the first valve is regulated.

In other words, the regulating valve element 350 is pushed into or pulled out of the hole 370 in a stepped manner or else without steps. The cross sections of the regulating valve element 350 and of the preferably round hole 370 are designed such that the cross section of the hole 370 is closed completely when the regulating valve element 350 is introduced completely, with the result that no exhaust gas mass flow can pass the first valve 190.

In one preferred embodiment, a valve seat ensures that the hole 370 is closed firmly.

Guidance of the regulating valve element 350 by the adjustment lever 330 on one side and by the valve housing 340 on the other side is therefore made possible by the design of the first valve 190.

FIG. 4a shows a side view of a detail of the first valve 190. By way of example, a regulating valve element 350 is shown in the form of a cone which can be introduced into the hole or valve opening 370. A valve seat 375 ensures defined closure of the hole 370 when the regulating valve element 350 is introduced completely. The valve is then closed. In FIG. 4a, the regulating valve element is situated by way of example in an extreme position.

FIG. 4b shows a sectional view of a plan view of the embodiment from FIG. 4a in the plane of the valve seat, the conical regulating valve element being situated in an intermediate position. In the intermediate position, the valve opening 370 is not closed completely. An opening area 380 which varies as a function of the penetration depth of the valve element is defined between the valve seat and that section of the valve element which is situated in the plane of the valve seat.

According to a further embodiment, a method for controlling the load of an engine is proposed. Here, an engine with a turbocharger, as described above, is provided. A part mass flow of the exhaust gas is branched off downstream of the engine and upstream of the turbine. This part mass flow which is branched off passes a bypass line, as has been described above.

According to embodiments of the present invention, that part mass flow of the exhaust gas which is to be branched off is regulated by a first valve in the bypass line. Before the part mass flow which is branched off reaches the first valve, it is cooled. This can take place, for example, by means of a cooling device, as is shown in FIGS. 3a to 3c.

According to one embodiment, the regulation is carried out by a regulating and/or control device which, as is shown in FIG. 2, can be connected to various components of the load control device, in order to communicate with them, to influence them, and/or to determine defined parameters, such as pressure differences and rotational speeds.

Embodiments of the regulating and/or control device can also be used to regulate defined components of the load control device in combination and/or as a function of one another, in order for it to be possible for the components which influence one another mutually to be regulated in an optimized manner.

The regulating and/or control device can also be designed to influence the first valve only at a defined time, for example when the throttle valve is already completely open. Before the intervention of the regulating and/or control device, the first valve can be operated, for example, in an actuating operation mode, as has already been described in greater detail above.

It has been shown that the present invention can also be used to avoid compressor surge (exceeding of the surge limit) in cold ambient conditions in the entire load range or in the case of load-controlled braking.

The present invention can be used in such a way that the load control in steady state high load operation no longer takes place by way of the throttle valve, but rather by way of the first valve (wastegate). As a result of this invention, an Otto engine can then be operated, for example, in an unthrottled manner and therefore at the maximum possible degree of efficiency.

In addition, regulation which is according to requirements and optimized in terms of the degree of efficiency can be made possible by the load control device and the method for load control according to the present invention and the effects achieved thereby, such as cooling of the part mass flow of the exhaust gas in the bypass line. As a result of the above-described invention, an increase in the degree of efficiency of the engine of

$$\frac{3}{10} \%$$

has been achieved, for example.

FIG. 5 shows a further embodiment of a cooling device 180a with a wastegate or first valve 190a. The cooling device 180a operates in the form of a heat exchanger. The exhaust gas is guided in a cylindrical bypass line 170a which has a first, rectilinear section 172a, which is arranged upstream of the wastegate 190a, and a second section 174a downstream of the wastegate 190a. In other embodiments, the bypass line can also have non-cylindrical line cross sections. Furthermore, the cooling device 180a has a water line 182a which serves to cool the exhaust gas which flows through the bypass line 170a. A rectilinear cooling section 184a of the water line is substantially cylindrical and surrounds the first section 172a of the bypass line 170a concentrically. The rectilinear cooling section can have a compensation region 185a, in order to compensate for a longitudinal expansion of the cooling section 184a. The cooling section 184a can also have other cross-sectional shapes. At its end which faces the wastegate, the cooling section 184a has a cooling water outlet 186a, through which the water which is heated by the exhaust gas flows out, and, at its end which faces away from the wastegate, has a cooling water inlet 187a, through which the cooling water is fed in. In one typical embodiment, the cooling section has a length of from 10 mm to 4000 mm, in particular of from 20 mm to 2000 mm. The length of the cooling section is adapted, in order to ensure sufficient cooling of the exhaust gas upstream of the wastegate 190a, in order that the wastegate 190a can operate at relatively low temperatures. The cooling water inlet 187a and the cooling water outlet 186a can in each case have a shut-off valve 188a. In other embodiments, the cooling water inlet can be realized at that end of the cooling section 184a which faces the wastegate 190a and the cooling water outlet can be realized at that end of the cooling section 184a which faces away from the wastegate. The cooling device 180a can be fastened by way of holding elements 189a. In other embodiments, another coolant can also be used instead of water.

FIGS. 6a and 6b show an embodiment of a wastegate or first valve 400 in the form of a rotary valve which can be used as a wastegate 190a in the cooling arrangement which is shown in FIG. 5. Here, FIG. 6a shows a half-section/exploded view and FIG. 6b shows a sectional view of the embodiment of the valve according to FIG. 6a. The wastegate 400 has a basic body 410 and a valve actuating element 420 which have a common longitudinal axis X which corresponds to the rotational axis of the valve actuating element 420. The basic body 410 comprises a cylindrical valve chamber 412 with a circumferential wall 414. The valve chamber 412 is connected via an axial opening 416 to a first section of the bypass line, for example the first section 172a from FIG. 5, and via a radial opening 418 in the circumferential wall 414 to a second section of the bypass line, for example the second section 174a from FIG. 5. Exhaust gas can therefore flow into the valve chamber 412 via the axial opening 416 which is, in particular, circular. The radial opening 418 is substantially rectangular in the embodiment which is shown in FIGS. 6a and 6b.

The valve actuating element 420 has an actuating rod 422 which is connected to a rotary drive (not shown), and a valve actuating element cylinder 424 which is of tubular form. The outer radius of the valve actuating element cylinder 424 corresponds substantially in terms of radius to the circumferential wall 414, with the result that the valve actuating element cylinder 424 can be moved or rotated in a sliding manner in the valve chamber 412. The valve actuating element cylinder 424 likewise has an axial opening 426 and a radial opening 428. The exhaust gas flows via the axial opening 426 into the interior of the valve actuating element cylinder 424.

The axial openings 418, 428 of the valve actuating element cylinder 424 and of the basic body 410 are formed in such a way that a rotation of the valve actuating element 420 about the rotational axis relative to the basic body 410 brings about a change in the overlapping part of the axial openings 418, 428. The opening cross section or the opening area of the wastegate 400 is therefore changed.

In order to make particularly fine regulation possible, the axial opening of the valve actuating element cylinder 424 does not have a rectangular opening, but rather a triangular opening, in which two edges correspond to the edges of the substantially rectangular, radial opening 418 of the basic body 410. In the embodiment which is shown in FIGS. 6a and 6b, the radial opening 428 of the valve actuating element cylinder 424 has a pentagonal basic shape, two edges corresponding to the edges of the substantially rectangular, radial opening 418 of the basic body 410, and two edges corresponding to a section of the two other edges of the radial opening 418 of the basic body. Not only can the shapes which are described here be used, but rather other shapes of radial openings are also possible. The exhaust gas flow can therefore be regulated by rotation of the valve actuating element 420.

FIGS. 7a and 7b show a further embodiment of a wastegate 500. The wastegate has a basic body 510, a valve actuating element 520 which can be moved in the axial direction X, and a valve lever 540 for moving the valve actuating element 520 between a first extreme position and a second extreme position. The basic body 510 has a valve seat 514 around an axial valve opening 512, which valve seat 514 can interact with a shoulder 522 of the valve actuating element 520, in order to suppress a flow of exhaust gas through the wastegate when the valve actuating element 520 is situated in one of the two extreme positions.

The valve seat 514 is arranged in a radial plane. The basic body 510 additionally has a radial opening 516, through which the gas which flows into a valve chamber 518 can flow out again. The valve actuating element 520 is arranged movably in the valve chamber 518.

Furthermore, the valve element has a control body 524 which projects from the shoulder and protrudes into the axial valve opening 512 during operation. Here, the control body 524 can completely leave the valve opening 512 in one of the two extreme positions of the valve actuating element.

The control body 524 comprises two control faces 526 which converge and have a common edge. The side edges 527 of the control faces are connected to one another in each case via a cylinder section 528. Here, the radius of the cylinder section 528 can be adapted to the radius of the axial opening or can correspond substantially to the latter. In other embodiments, the radius of the cylinder sections can be smaller than the radius of the axial opening. The control body 524 which projects from the shoulder has a substantially conical or pyramid-like shape which makes it possible to regulate the exhaust gas flow precisely. In FIGS. 7a and 7b, the opening cross section and therefore the exhaust gas flow are regulated via a linear movement of the valve cone or control body. In comparison with the rotary valve which is shown in FIGS. 6a and 6b, a smaller fitting face is advantageous which can lead to jamming of the valve as a result of deposits or warping. Furthermore, in the closed position, the sealing action can be ensured in an improved manner by sealing faces which lie on one another without play, for example in the form of the valve seat 514 and the shoulder 522.

FIGS. 8a and 8b show a further embodiment of a wastegate or first valve 600. The wastegate has a tubular basic body 610, in which a rotatably mounted throttle valve 620 is arranged which can be moved via a drive. The internal diameter of the tubular basic body 610 widens here in steps in the flow direction of the exhaust gas. The throttle valve 620 is designed in such a way that, in a first rotary position, it can close the tubular basic body completely and, in a second rotary position, it can release a gas flow through the tubular basic body almost completely. In the wastegate which is shown in FIG. 8, the opening cross section and therefore the exhaust gas flow are varied via a rotational movement. This embodiment is favorable and has few components.

Those features of the invention which are disclosed in the above description, in the claims and in the drawings can be essential to the realization of the invention in its various embodiments both individually and in every desired combination.

1.-21. (canceled)

22. A load control device for an engine comprising:
a compressor for compressing air or an air/fuel mixture in an intake section of the engine;
an exhaust gas line for discharging an exhaust gas mass flow from the engine;
a turbine which is driven by an exhaust gas mass flow fed by the exhaust gas line and which drives the compressor;
a bypass line which branches off from the exhaust gas line upstream of the turbine, a first valve being arranged for serving to regulate and/or control the exhaust gas mass flow in the bypass line; and
a cooling device which is arranged upstream of the first valve, for cooling the exhaust gas mass flow.

23. The load control device as claimed in claim 22, the cooling device being a heat exchanger.

24. The load control device as claimed in claim 22, further comprising a movable valve actuating element of the first valve being configured in such a way that an opening area of the first valve has different sizes, in particular in the case of a movement of the valve actuating element between a first extreme position and a second extreme position.

25. The load control device as claimed in claim 24, wherein the size of the opening area decreasing continuously, in particular decreasing linearly at least in sections, for example completely, between the first extreme position and the second extreme position of the movable valve actuating element.

26. The load control device as claimed in claim 24, the movable valve actuating element having a pyramid-like or conical shape on the side which faces the valve opening.

27. The load control device as claimed in claim 26, it being possible for the movable valve actuating element to be moved by means of an adjustment lever which is guided, in particular, by a valve housing.

28. The load control device as claimed in claim 22, the load control device comprising a second valve, in particular a throttle valve, which is arranged downstream of the compressor and in front of the engine, the second valve controlling and/or regulating the air or air/fuel mixture which is fed to the engine.

29. The load control device as claimed in claim 28, comprising, furthermore: a regulating and/or control device for controlling and/or regulating the first valve and, typically, also the second valve, the regulating and/or control device being set up to carry out the control and/or the regulation of the first valve, or to carry out the control and/or the regulation of the first valve and of the second valve as a function of one another.

30. The load control device as claimed in claim 29, the regulating and/or control device being set up to carry out the control and/or the regulation of the first valve and/or of the second valve as a function of a pressure difference at the second valve.

31. The load control device as claimed in claim 29, the regulating and/or control device being set up to carry out the control and/or the regulation of the first valve and/or second valve as a function of a reference signal of a shaft rotational speed of the turbine.

32. The load control device as claimed in claim 22, the engine being a gaseous fuel engine, being an Otto engine, and/or the engine being adapted for use in a biogas plant.

33. A method for controlling the load of an engine, comprising:
branching off of a part of an exhaust gas mass flow of the engine upstream of a turbine into a bypass line, the exhaust gas mass flow which is branched off being regulated and/or controlled in a bypass line by means of a first valve; and
cooling of the exhaust gas flow which is branched off, upstream of the first valve.

34. The method as claimed in claim 33, wherein an opening area or an opening area size of the first valve being controlled and/or regulated in such a way that, during the load control, a second valve which is arranged downstream of the compressor is completely open.

35. The method as claimed in claim 34, wherein a load control management means being incorporated which is configured for a combined load control of the second valve with the first valve.

36. The method as claimed in claim 33, wherein a valve actuating element of the first valve being guided on one side by an adjustment lever and on another side by a valve housing.

37. The method as claimed in claim 34, wherein a pressure difference at the second valve being used as a controlled variable before the transfer of the load control from the second valve to the first valve.

38. The method as claimed in claim 33, wherein a reference signal of a shaft rotational speed of the turbine being used as a controlled variable.

39. The method as claimed in claim 33, wherein the cooling of the exhaust gas mass flow which is branched off taking place in a manner which is adapted to a dew point of the exhaust gas and/or of a constituent part of the exhaust gas.

40. The method as claimed in claim 39, wherein a temperature of the exhaust gas mass flow being adapted, controlled and/or regulated in such a way that it exceeds the dew point and/or an acid dew point.

41. The method as claimed in claim 33, wherein the first valve not being cooled actively.

42. The method as claimed in claim 33, for operating a load control device for an engine comprising:
a compressor for compressing air or an air/fuel mixture in an intake section of the engine;
an exhaust gas line for discharging the exhaust gas mass flow from the engine;
the turbine which is driven by the exhaust gas mass flow fed by the exhaust gas line and which drives the compressor;
the bypass line which branches off from the exhaust gas line upstream of the turbine, the first valve being arranged for serving to regulate and/or control the exhaust gas mass flow in the bypass line; and
a cooling device which is arranged upstream of the first valve, for cooling the exhaust gas mass flow.
